(19) United States
(12) Patent Application Publication
(10) Pub. No.: US 2025/0039466 A1
(43) Pub. Date: Jan. 30, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Kai ZHANG, Los Angeles, CA (US); Xi Xie, Beijing (CN); Li Zhang, Los Angeles, CA (US)

(21) Appl. No.: 18/913,910

(22) Filed: Oct. 11, 2024

Related U.S. Application Data
(63) Continuation of application No. PCT/CN2023/087883, filed on Apr. 12, 2023.

(30) Foreign Application Priority Data
Apr. 13, 2022 (WO) PCT/CN2022/086533

(51) Int. Cl. H04N 19/80; H04N 19/105; H04N 19/117; H04N 19/159; H04N 19/176; H04N 19/186

(52) U.S. Cl. CPC H04N 19/80; H04N 19/105; H04N 19/117; H04N 19/159; H04N 19/176; H04N 19/186

(57) ABSTRACT

Embodiments of the disclosure provide a solution for video processing. A method for video processing is proposed. The method includes: determining, for a conversion between a video unit of a video and a bitstream of the video, a chroma interpolation filter for the video unit using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; and performing the conversion based on the chroma prediction block.

### CROSS-REFERENCE TO RELATED APPLICATIONS

This application is a continuation of International Application No. PCT/CN2023/087883, filed on Apr. 12, 2023, which claims the benefit of International Application No. PCT/CN2022/086533 filed on Apr. 13, 2022. The entire contents of these applications are hereby incorporated by reference in their entireties.

### FIELDS

Embodiments of the present disclosure relates generally to video coding techniques, and more particularly, to long tap chroma interpolation filter.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a chroma interpolation filter for the video unit using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; and performing the conversion based on the chroma prediction block. Compared with the conventional solution, some embodiments of the present disclosure can advantageously improve the coding efficiency, coding gain, coding performance, and flexibility.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a chroma interpolation filter for a video unit of the video using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; and generating the bitstream based on the chroma prediction block.

In a fifth aspect, a method for storing a bitstream of a video is proposed. The method comprises: determining a chroma interpolation filter for a video unit of the video using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; generating the bitstream based on the chroma prediction block; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a schematic diagram of Group of Pictures (GOP)-16 structure;

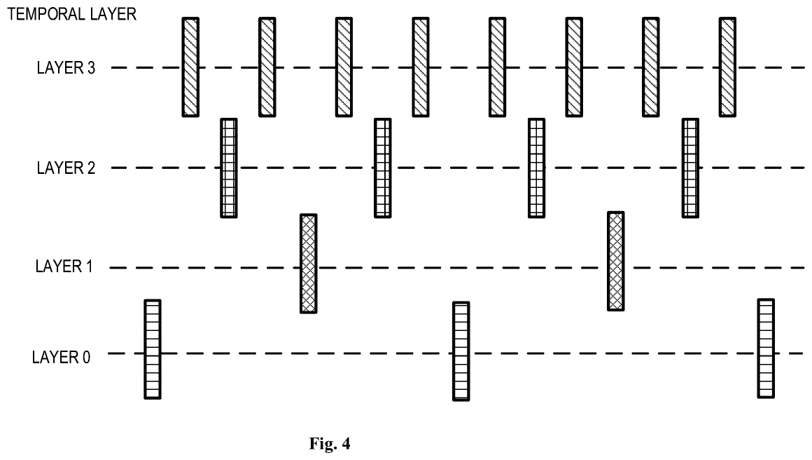

FIG. 5 illustrates a schematic diagram of GOP-32 structure;

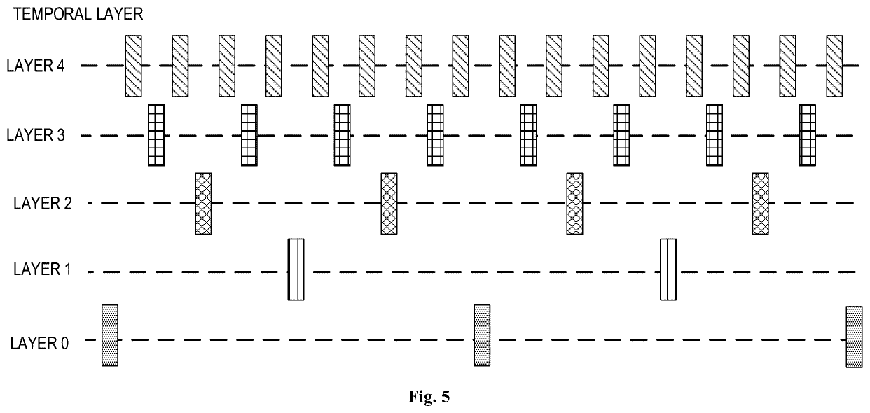

FIG. 6 illustrates a flowchart of a method according to some embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

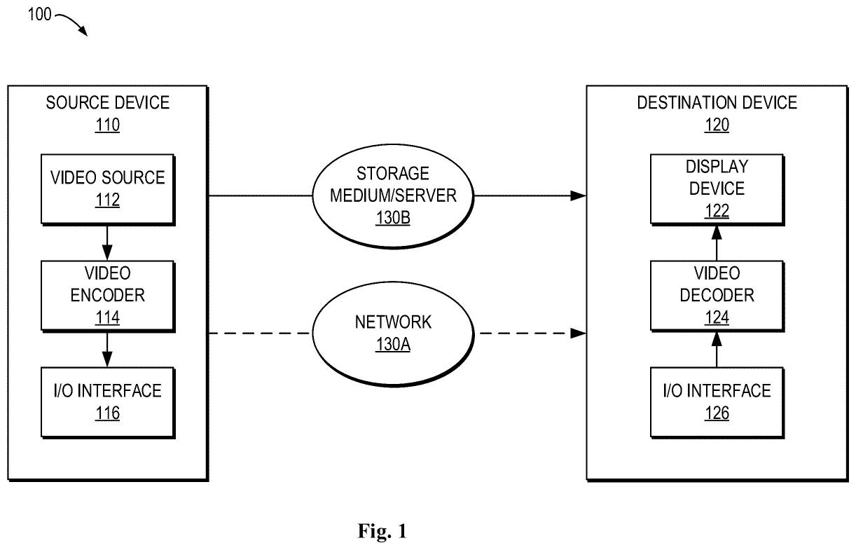

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

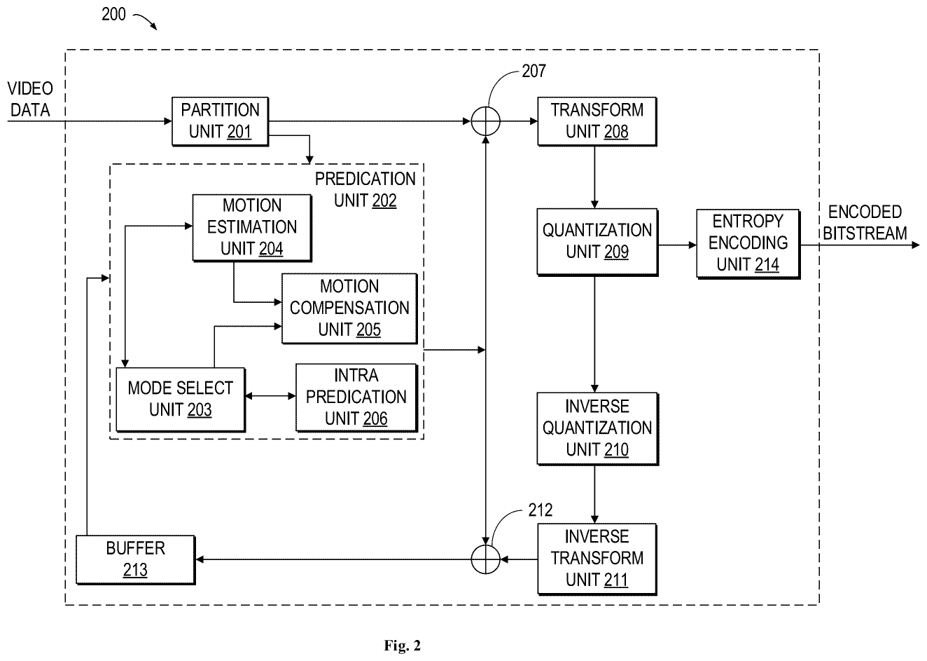

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

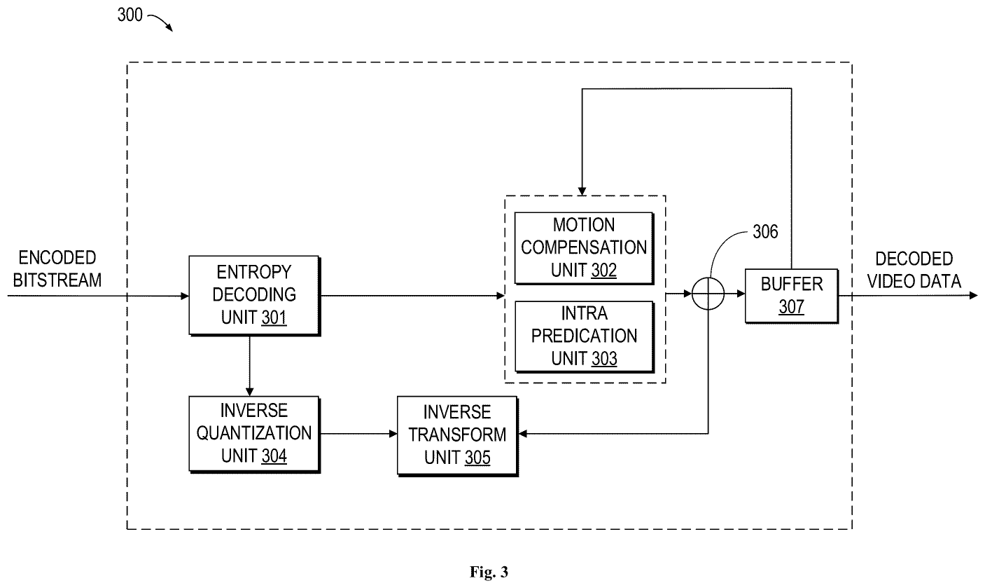

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block.

The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 BRIEF SUMMARY

The present disclosure is related to video coding technologies. Specifically, it is related to chroma interpolation filter in video coding. It may be applied to the existing video coding standard like HEVC, or the standard (Versatile Video Coding). It may be also applicable to future video coding standards or video codec.

### 2 INTRODUCTION

### 2.1 Interpolation in Motion Compensation

Inter prediction can save transmitted information by eliminating temporal redundancy. Motion compensation is an important operation in inter prediction. Motion vector and the reference frame index are used to indicate the displacement between the current prediction unit and the reference block. Thus, each prediction unit can find the reference block based on the motion vector and the reference frame index. Since the displacement information can be continuous and the reference pixel is spatially discrete, the displacement information may point to a fractional position between two adjacent integer pixels. Therefore, to obtain prediction block with fractional motion vector, the reference block needs to be interpolated by using interpolation filter. The number of fractional positions depends on the resolution of the motion vector. If the motion vector resolution is 1/n, then there are (n−1) fractional position that need to be interpolated. Each fractional position corresponds to an N-tap interpolation filter which contains N filter coefficients.

### 2.2 Development of Interpolation Filters

The coefficients of the filter are pre-calculated using the interpolation filter. In H.264/AVC, the interpolation coefficients are calculated using the lanczos filter. In H.265/HEVC and H.266/VVC, the interpolation coefficients are calculated using the DCT-IF filter. In H.265/HEVC, the resolution of the motion vector is 1/4, so the number of fractional positions of the luma component is 3. In H.266/VVC, the resolution of the motion vector can reach to 1/16 for luma component and 1/32 for chroma component for video in 4:2:0 color format. Thus the number of fractional positions of the luma component is 16. and the number of fractional positions of the chroma component is 32.

### 3 PROBLEMS

1. When interpolating the reference block, the long-tap filter can obtain more pixel information from the reference block compared to the short-tap filter. The increase in the number of taps has been shown to gain performance in the luma component. Therefore, the number of interpolation taps for the luma component has been increased to 12 in the latest generation of the Test model. However, the interpolation filter for the chroma component is a 4-tap interpolation filter which cannot be used to obtain high quality interpolation results.

2. In the reference structure of the random access configuration, all the temporal layers use the same interpolation filter. Considering the different quality and interpolation computational complexity of different temporal layers, allowing different temporal layers to use interpolation filters with different number of taps can achieve a better tradeoff.

### 4 DETAILED SOLUTIONS

The detailed embodiments below should be considered as examples to explain general concepts. These embodiments should not be interpreted in a narrow way. Furthermore, these embodiments can be combined in any manner.

To solve the above problems, this document proposes the following approach.

1. Chroma interpolation filtering by at least one filter with taps more than four (named a long tap chroma interpolation filter, LTCIF) is proposed on at least one chroma component.
a) In one example, a chroma prediction block can be obtained by interpolating the chroma reference block using a long tap chroma interpolation filter in motion compensation.
b) In one example, a chroma prediction block can be obtained by interpolating the chroma reference samples using a long tap chroma interpolation filter in intra-prediction.
c) A long tap chroma interpolation filter comprises a set of pre-calculated/or on-line signaled filter coefficients.

2. For one example, LTCIF may be calculated using discrete cosine transform interpolation filter (DCT-IF).
a) For example, LTCIF may be calculated using DCT-IF with cosine window. The filter coefficients are calculated using equations as below.

$${D}_{k} = \frac{2}{Size} \cdot cos ( \frac{π \cdot k \cdot ( 2 \cdot l - 2 \cdot Center + Size )}{2 \cdot Size} )$$

$${W}_{k} = cos ( \frac{π \cdot k \cdot ( 2 \cdot α - 2 \cdot Center + Size )}{2 \cdot Size} ) ;$$

$${W}_{0} = \frac{1}{2} ; 1 \leq k \leq Size - 1$$

$${Filter}_{l} ( α ) = cos ( π \cdot \frac{l - β}{N} ) \cdot {\sum }_{k = 0}^{Size - 1} {W}_{k} ( α ) \cdot {D}_{l k}$$

$${p}_{α} = {\sum }_{l = {M}_{min}}^{{M}_{max}} {Filter}_{l} ( α ) \cdot {p}_{l}$$

$$Size = ( {M}_{min} + {M}_{max} - 1 )$$

$$Center = \frac{{M}_{min} + {M}_{max}}{2}$$

where {pₗ} denote set of sample values at integer position l used to interpolation p_{α} at fractional position α. Filterₗ (α) indicate the filter coefficient. Mₘᵢₙ and Mₘₐₓ indicate the range of neighboring integer-position samples involved in the interpolation process. Size is the number of reference samples used in the interpolation filter. N is smoothing window size, which is not necessarily an integer.
b) For one example, LTCIF may be calculated using DCT-IF with frequency domain smoothing. The filter coefficients are calculated using equations as below.

$${D}_{k} = \frac{2}{Size} \cdot cos ( \frac{π \cdot k \cdot ( 2 \cdot l - 2 \cdot Center + Size )}{2 \cdot Size} )$$

$${W}_{k} = cos ( \frac{π \cdot k \cdot ( 2 \cdot α - 2 \cdot Center + Size )}{2 \cdot Size} ) ;$$

$${W}_{0} = \frac{1}{2} ; 1 \leq k \leq Size - 1$$

$${\tilde{W}}_{k} ( α ) = \frac{{W}_{k} ( α )}{1 + σ \cdot {k}^{2}} ; σ \geq 0$$

$${Filter}_{l} ( α ) = {\sum }_{k = 0}^{S i z e - 1} {\tilde{W}}_{k} ( α ) \cdot {D}_{l k}$$

$${p}_{α} = {\sum }_{l = {M}_{min}}^{{M}_{max}} {Filter}_{l} ( α ) \cdot {p}_{l}$$

$$Size = ( {M}_{min} + {M}_{max} - 1 )$$

$$Center = \frac{{M}_{min} + {M}_{max}}{2}$$

where {pₗ} denote set of sample values at integer position l used to interpolation p_{α} at fractional position α. Filterₗ (α) indicate the filter coefficient. Mₘᵢₙ and Mₘₐₓ indicate the range of neighboring integer-position samples involved in the interpolation process. Size is the number of reference samples used in the interpolation filter. N is smoothing window size, which is not necessarily an integer. σ is smoothing parameter.

1. For one example, LTCIF may be calculated using Lanczos interpolation filter (DCT-IF). The filter coefficients are calculated using equations as below.

$${Filter}_{n} ( x ) = \{ \begin{matrix}sin c ( x ) sin c ( \frac{x}{n} ) , & - n < x < n \\ 1 , & x = 0 \\ 0 , & otherwise\end{matrix}$$

$${p}_{α} = {\sum }_{l = - n + 1}^{n} {Filter}_{n} ( α - l ) \cdot {p}_{l}$$

$$sin c ( x ) = \frac{sin π x}{π x}$$

$$n = \frac{Size}{2}$$

where {pₗ} denote set of sample values at integer position l used to interpolation p_{α} at fractional position α. Size is the number of reference samples used in the interpolation filter.

2. In one example, the usage of chroma interpolation filter may be dependent on temporal layers.
a) For example, the long tap chroma interpolation filter is used for layers with temporal id less than or equal to k. And layers with temporal id greater than k may use the 4-tap chroma interpolation filter.
b) Example of temporal ids of GOP-16 and GOP-32 are shown in FIG. 1 and FIG. 2, respectively, wherein k is set to be 4.
c) For example, chroma interpolation filters with different number of taps may be used for different temporal layers.
d) For example, chroma interpolation filters with different filter taps may be used for different temporal layers.

3. In one example, the usage of chroma interpolation filter may be dependent on coding information.
a) For example, the coding information may comprise QP values.
   i. For example, chroma interpolation filters with different number of taps may be used for different QPs.
   ii. For example, chroma interpolation filters with different filter taps may be used for different QPs.
b) For example, the coding information may comprise W and/or H, which represent the width and height of the current block or the current tile or the current picture.
   i. For example, chroma interpolation filters with different number of taps may be used for different W or H or W*H or max (W,H) or min (W,H).
   ii. For example, chroma interpolation filters with different filter taps may be used for different W or H or W*H or max (W,H) or min (W,H).
c) For example, the coding information may comprise the precision of MV or MVD.
   i. For example, chroma interpolation filters with different number of taps may be used for different precisions of MV or MVD.
   ii. For example, chroma interpolation filters with different filter taps may be used for different precisions of MV or MVD.
d) For example, the coding information may comprise the coding mode.
   i. For example, chroma interpolation filters with different number of taps may be used for different intra-prediction modes.
   ii. For example, chroma interpolation filters with different filter taps may be used for different intra-prediction modes.
   iii. For example, chroma interpolation filters with different number of taps may be used for different inter modes, such merge/affine/AMVP/GMVD/BCW/CIIP/etc.
   iv. For example, chroma interpolation filters with different filter taps may be used for different inter modes, such as merge/affine/AMVP/GMVD/BCW/CIIP/etc.
   v. For example, chroma interpolation filters with different number of taps may be used for different inter-prediction direction such as uni-prediction or bi-prediction.
   vi. For example, chroma interpolation filters with different filter taps may be used for different inter-prediction direction such as uni-prediction or bi-prediction.
   vii. For example, chroma interpolation filters with different number of taps may be used depending on the resolution of the reference picture.
   viii. For example, chroma interpolation filters with different filter taps may be used depending on the resolution of the reference picture.

4. In one example, the usage of chroma interpolation filter may be dependent on the color component (such as Cb or Cr) or color format (such as RGB or YUV or 4:2:0 or 4:2:2 or 4:4:4).
a) For example, chroma interpolation filters with different number of taps may be used for different color components or color formats.
b) For example, chroma interpolation filters with different filter taps may be used for different color components or color formats.

5. In one example, the filtered results of LTCIF may be clipped.

6. In one example, the usage of chroma interpolation filter may be signaled from an encoder to a decoder.
a) For example, at least one index or flag to indicate which chroma interpolation filter may be signaled from the encoder to the decoder.
   i. For example, a flag may be signaled to indicate whether LTCIF or 4-tap filter is used.
b) For example, at least one chroma interpolation filter coefficient may be derived based on information signaled from the encoder to the decoder.
c) The signaling may be presented in SPS/PPS/APS/picture header/slice header/CTU/CU/PU or any other units at sequence level/picture level/slice level/block level.

### 5 EMBODIMENTS

The filter coefficients of LTCIF can be the following coefficients.
a) When the number of taps is 6, the coefficients are as follows.

| Fractional | Coefficients (6 taps) |
|---|---|
| position α | {C₀, C₁, . . . Cₙ} n = 5 |
| 1/32 | {0, 0, 256, 0, 0, 0}, |
| 2/32 | {1, −6, 256, 7, −2, 0}, |
| 3/32 | {2, −11, 253, 15, −4, 1}, |
| 4/32 | {3, −16, 251, 23, −6, 1}, |
| 5/32 | {4, −21, 248, 33, −10, 2}, |
| 6/32 | {5, −25, 244, 42, −12, 2}, |
| 7/32 | {7, −30, 239, 53, −17, 4}, |
| 8/32 | {7, −32, 234, 62, −19, 4}, |
| 6/32 | {8, −35, 227, 73, −22, 5}, |
| 7/32 | {9, −38, 220, 84, −26, 7}, |
| 8/32 | {10, −40, 213, 95, −29, 7}, |
| 9/32 | {10, −41, 204, 106, −31, 8}, |
| 10/32 | {10, −42, 196, 117, −34, 9}, |
| 11/32 | {10, −41, 187, 127, −35, 8}, |
| 12/32 | {11, −42, 177, 138, −38, 10}, |
| 13/32 | {10, −41, 168, 148, −39, 10}, |
| 14/32 | {10, −40, 158, 158, −40, 10}, |
| 15/32 | {10, −39, 148, 168, −41, 10}, |
| 16/32 | {10, −38, 138, 177, −42, 11}, |
| 17/32 | {8, −35, 127, 187, −41, 10}, |
| 18/32 | {9, −34, 117, 196, −42, 10}, |
| 19/32 | {8, −31, 106, 204, −41, 10}, |
| 20/32 | {7, −29, 95, 213, −40, 10}, |
| 21/32 | {7, −26, 84, 220, −38, 9}, |
| 22/32 | {5, −22, 73, 227, −35, 8}, |
| 23/32 | {4, −19, 62, 234, −32, 7}, |
| 24/32 | {4, −17, 53, 239, −30, 7}, |
| 25/32 | {2, −12, 42, 244, −25, 5}, |
| 26/32 | {2, −10, 33, 248, −21, 4}, |
| 27/32 | {1, −6, 23, 251, −16, 3}, |
| 28/32 | {1, −4, 15, 253, −11, 2}, |
| 31/32 | {0, −2, 7, 256, −6, 1}, |

b) When the number of taps is 8, the coefficients are as follows.

| Fractional | Coefficients (8 taps) |
|---|---|
| position α | {C₀, C₁, . . . Cₙ} n = 7 |
| 1/32 | {0, 0, 0, 256, 0, 0, 0, 0, }, |
| 2/32 | {0, 2, −8, 256, 8, −4, 2, 0, }, |
| 3/32 | {0, 4, −12, 252, 16, −8, 4, 0, }, |
| 4/32 | {0, 4, −16, 248, 24, −8, 4, 0, }, |
| 5/32 | {−4, 8, −20, 248, 32, −12, 4, 0, }, |
| 6/32 | {0, 8, −28, 244, 40, −12, 4, 0, }, |
| 7/32 | {−4, 12, −32, 240, 52, −16, 4, 0, }, |
| 8/32 | {−4, 12, −36, 236, 60, −16, 4, 0, }, |
| 6/32 | {−4, 16, −40, 232, 68, −20, 4, 0, }, |
| 7/32 | {−4, 16, −40, 220, 84, −28, 12, −4, }, |
| 8/32 | {−4, 16, −44, 208, 104, −32, 12, −4, }, |
| 9/32 | {−4, 16, −44, 204, 108, −32, 12, −4, }, |
| 10/32 | {−4, 12, −36, 188, 124, −40, 16, −4, }, |
| 11/32 | {−4, 16, −44, 188, 128, −36, 12, −4, }, |
| 12/32 | {−4, 16, −44, 180, 136, −40, 16, −4, }, |
| 13/32 | {−4, 16, −44, 168, 148, −40, 16, −4, }, |
| 14/32 | {−4, 16, −44, 160, 160, −44, 16, −4, }, |
| 15/32 | {−4, 16, −40, 148, 168, −44, 16, −4, }, |
| 16/32 | {−4, 16, −40, 136, 180, −44, 16, −4, }, |
| 17/32 | {−4, 12, −36, 128, 188, −44, 16, −4, }, |
| 18/32 | {−4, 16, −40, 124, 188, −36, 12, −4, }, |
| 19/32 | {−4, 12, −32, 108, 204, −44, 16, −4, }, |
| 20/32 | {−4, 12, −32, 104, 208, −44, 16, −4, }, |
| 21/32 | {−4, 12, −28, 84, 220, −40, 16, −4, }, |
| 22/32 | {0, 4, −20, 68, 232, −40, 16, −4, }, |
| 23/32 | {0, 4, −16, 60, 236, −36, 12, −4, }, |
| 24/32 | {0, 4, −16, 52, 240, −32, 12, −4, }, |
| 25/32 | {0, 4, −12, 40, 244, −28, 8, 0, }, |
| 26/32 | {0, 4, −12, 32, 248, −20, 8, −4, }, |
| 27/32 | {0, 4, −8, 24, 248, −16, 4, 0, }, |
| 28/32 | {0, 4, −8, 16, 252, −12, 4, 0, }, |
| 31/32 | {0, 2, −4, 8, 256, −8, 2, 0, }, |

c) When the number of taps is 12, the coefficients are as follows.

| Fractional | Coefficients (12 taps) |
|---|---|
| position α | {C₀, C₁, . . . Cₙ} n = 11 |
| 1/32 | {0, 0, 0, 0, 0, 256, 0, 0, 0, 0, 0, 0, }, |
| 2/32 | {0, 1, −1, 3, −7, 255, 8, −3, 1, −1, 0, 0, }, |
| 3/32 | {−1, 2, −3, 6, −14, 254, 16, −7, 4, −2, 1, 0, }, |
| 4/32 | {−1, 2, −4, 8, −20, 252, 25, −10, 5, −2, 1, 0, }, |
| 5/32 | {−1, 3, −7, 12, −26, 249, 35, −15, 8, −4, 2, 0, }, |
| 6/32 | {−1, 3, −6, 13, −31, 246, 44, −17, 8, −3, 1, −1, }, |
| 7/32 | {−2, 5, −9, 17, −36, 241, 54, −22, 12, −6, 3, −1, }, |
| 8/32 | {−1, 3, −8, 17, −39, 237, 64, −24, 11, −5, 2, −1, }, |
| 6/32 | {−2, 5, −11, 21, −43, 230, 75, −29, 15, −8, 4, −1, }, |
| 7/32 | {−1, 4, −9, 20, −44, 222, 85, −30, 14, −6, 2, −1, }, |
| 8/32 | {−2, 6, −13, 24, −48, 216, 97, −36, 19, −10, 4, −1, }, |
| 9/32 | {−1, 4, −10, 21, −48, 208, 107, −36, 17, −8, 3, −1, }, |
| 10/32 | {−2, 7, −14, 25, −51, 200, 119, −42, 22, −12, 5, −1, }, |
| 11/32 | {−1, 4, −10, 22, −49, 192, 128, −42, 19, −9, 3, −1, }, |
| 12/32 | {−2, 7, −14, 26, −51, 181, 140, −46, 24, −13, 6, −2, }, |
| 13/32 | {−1, 4, −10, 22, −48, 171, 150, −46, 21, −10, 4, −1, }, |
| 14/32 | {−2, 6, −13, 25, −50, 162, 162, −50, 25, −13, 6, −2, }, |
| 15/32 | {−1, 4, −10, 21, −46, 150, 171, −48, 22, −10, 4, −1, }, |
| 16/32 | {−2, 6, −13, 24, −46, 140, 181, −51, 26, −14, 7, −2, }, |
| 17/32 | {−1, 3, −9, 19, −42, 128, 192, −49, 22, −10, 4, −1, }, |
| 18/32 | {−1, 5, −12, 22, −42, 119, 200, −51, 25, −14, 7, −2, }, |
| 19/32 | {−1, 3, −8, 17, −36, 107, 208, −48, 21, −10, 4, −1, }, |
| 20/32 | {−1, 4, −10, 19, −36, 97, 216, −48, 24, −13, 6, −2, }, |
| 21/32 | {−1, 2, −6, 14, −30, 85, 222, −44, 20, −9, 4, −1, }, |
| 22/32 | {−1, 4, −8, 15, −29, 75, 230, −43, 21, −11, 5, −2, }, |
| 23/32 | {−1, 2, −5, 11, −24, 64, 237, −39, 17, −8, 3, −1, }, |
| 24/32 | {−1, 3, −6, 12, −22, 54, 241, −36, 17, −9, 5, −2, }, |
| 25/32 | {−1, 1, −3, 8, −17, 44, 246, −31, 13, −6, 3, −1, }, |
| 26/32 | {0, 2, −4, 8, −15, 35, 249, −26, 12, −7, 3, −1, }, |
| 27/32 | {0, 1, −2, 5, −10, 25, 252, −20, 8, −4, 2, −1, }, |
| 28/32 | {0, 1, −2, 4, −7, 16, 254, −14, 6, −3, 2, −1, }, |
| 31/32 | {0, 0, −1, 1, −3, 8, 255, −7, 3, −1, 1, 0, }, |

d) When the number of taps is 16, the coefficients are as follows.

| Fractional | Coefficients (16 taps) |
|---|---|
| position α | {C₀, C₁, . . . Cₙ} n = 15 |
| 1/32 | {0, 0, 0, 0, 0, 0, 0, 256, 0, 0, 0, 0, 0, 0, 0, 0, }, |
| 2/32 | {0, 0, −1, 1, −2, 4, −8, 256, 8, −4, 2, −1, 1, 0, 0, 0, }, |
| 3/32 | {0, 1, −1, 2, −4, 7, −15, 254, 17, −7, 4, −3, 2, −1, 0, 0, }, |
| 4/32 | {0, 1, −2, 4, −6, 10, −21, 251, 26, −11, 6, −4, 2, −1, 1, 0, }, |
| 5/32 | {−1, 1, −3, 5, −8, 13, −27, 250, 35, −15, 9, −5, 3, −2, 1, 0, }, |
| 6/32 | {−1, 2, −3, 6, −9, 16, −32, 244, 45, −19, 11, −7, 4, −2, 1, 0, }, |
| 7/32 | {−1, 2, −4, 7, −11, 18, −37, 242, 55, −23, 13, −8, 5, −3, 1, 0, }, |
| 8/32 | {−1, 2, −4, 7, −12, 20, −41, 238, 65, −27, 15, −9, 5, −3, 1, 0, }, |
| 6/32 | {−1, 2, −5, 8, −13, 22, −44, 229, 76, −30, 17, −10, 6, −3, 2, 0, }, |
| 7/32 | {−1, 3, −5, 9, −14, 24, −47, 223, 86, −34, 19, −12, 7, −4, 2, 0, }, |
| 8/32 | {−1, 3, −5, 9, −15, 25, −49, 215, 97, −37, 21, −13, 8, −4, 2, 0, }, |
| 9/32 | {−1, 3, −6, 10, −16, 27, −51, 209, 108, −40, 22, −14, 8, −5, 2, 0, }, |
| 10/32 | {−1, 3, −6, 10, −16, 27, −52, 199, 119, −43, 24, −14, 9, −5, 2, 0, }, |
| 11/32 | {−1, 3, −6, 10, −17, 28, −53, 193, 130, −46, 25, −15, 9, −5, 2, −1, }, |
| 12/32 | {−1, 3, −6, 10, −17, 28, −53, 182, 141, −48, 26, −16, 10, −5, 3, −1, }, |
| 13/32 | {−1, 3, −6, 10, −17, 28, −52, 172, 152, −50, 27, −16, 10, −6, 3, −1, }, |
| 14/32 | {−1, 3, −6, 10, −17, 28, −51, 162, 162, −51, 28, −17, 10, −6, 3, −1, }, |
| 15/32 | {−1, 3, −6, 10, −16, 27, −50, 152, 172, −52, 28, −17, 10, −6, 3, −1, }, |
| 16/32 | {−1, 3, −5, 10, −16, 26, −48, 141, 182, −53, 28, −17, 10, −6, 3, −1, }, |
| 17/32 | {−1, 2, −5, 9, −15, 25, −46, 130, 193, −53, 28, −17, 10, −6, 3, −1, }, |
| 18/32 | {0, 2, −5, 9, −14, 24, −43, 119, 199, −52, 27, −16, 10, −6, 3, −1, }, |
| 19/32 | {0, 2, −5, 8, −14, 22, −40, 108, 209, −51, 27, −16, 10, −6, 3, −1, }, |
| 20/32 | {0, 2, −4, 8, −13, 21, −37, 97, 215, −49, 25, −15, 9, −5, 3, −1, }, |
| 21/32 | {0, 2, −4, 7, −12, 19, −34, 86, 223, −47, 24, −14, 9, −5, 3, −1, }, |
| 22/32 | {0, 2, −3, 6, −10, 17, −30, 76, 229, −44, 22, −13, 8, −5, 2, −1, }, |
| 23/32 | {0, 1, −3, 5, −9, 15, −27, 65, 238, −41, 20, −12, 7, −4, 2, −1, }, |
| 24/32 | {0, 1, −3, 5, −8, 13, −23, 55, 242, −37, 18, −11, 7, −4, 2, −1, }, |
| 25/32 | {0, 1, −2, 4, −7, 11, −19, 45, 244, −32, 16, −9, 6, −3, 2, −1, }, |
| 26/32 | {0, 1, −2, 3, −5, 9, −15, 35, 250, −27, 13, −8, 5, −3, 1, −1, }, |
| 27/32 | {0, 1, −1, 2, −4, 6, −11, 26, 251, −21, 10, −6, 4, −2, 1, 0, }, |
| 28/32 | {0, 0, −1, 2, −3, 4, −7, 17, 254, −15, 7, −4, 2, −1, 1, 0, }, |
| 31/32 | {0, 0, 0, 1, −1, 2, −4, 8, 256, −8, 4, −2, 1, −1, 0, 0, }, |

The above coefficients are scaled up by 256, so that the chroma interpolation is calculated as follows.

$${p}_{α} = \frac{{\sum }_{l = 0}^{Size - 1} {C}_{l} {p}_{l}}{256}$$

where {pₗ} denote a set of sample values at integer position l used to interpolation p_{α} at fractional position α. Size is the number of reference samples used in the interpolation filter. Cₗ is the filtering coefficient in the table above.

Embodiments of the present disclosure are related to chroma interpolation filter.

As used herein, the terms “video unit” or “coding unit” or “block” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block (PB), a transform block (TB), a block, a sub-block of a block, a sub-region within the block, or a region that comprises more than one sample or pixel.

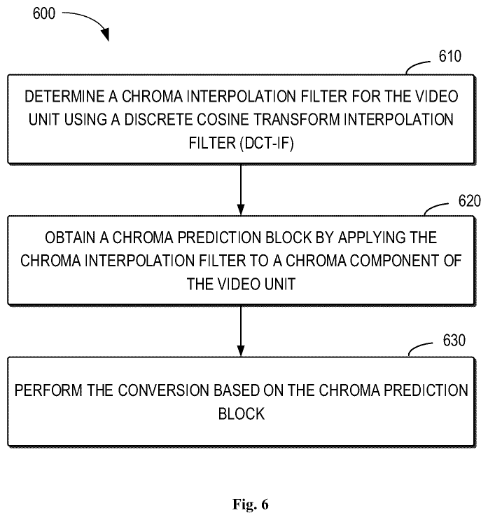

FIG. 6 illustrates a flowchart of a method 600 for video processing in accordance with some embodiments of the present disclosure. The method 600 is implemented during a conversion between a video unit and a bitstream of the video.

At block 610, for a conversion between a video unit of a video and a bitstream of the video, a chroma interpolation filter is determined for the video unit using a discrete cosine transform interpolation filter (DCT-IF). The number of taps of the chroma interpolation filter is larger than a predetermined number. For example, the predetermined number may be 4. The chroma interpolation filter with taps more than the predetermined number may refer to a long tap chroma interpolation filter (LTCIF).

At block 620, a chroma prediction block is obtained by applying the chroma interpolation filter to a chroma component of the video unit. In some embodiments, the chroma prediction block may be obtained by interpolating a chroma reference block using the chroma interpolation filter in motion compensation. Alternatively, the chroma prediction block may be obtained by interpolating a chroma reference samples using the chroma interpolation filter in intra-prediction. In some embodiments, a filtered result of the chroma interpolation filter may be clipped.

At block 630, the conversion is performed based on the chroma prediction block. In some embodiments, the conversion may include encoding the video unit into the bitstream. Alternatively, or in addition, the conversion may include decoding the video unit from the bitstream. In this way, high quality interpolation results can be obtained. Compared with the conventional solution, some embodiments of the present disclosure can advantageously improve the coding efficiency, coding gain, coding performance, and flexibility.

In some embodiments, the chroma interpolation filter is determined using DCT-IF with cosine window. For example, a wherein a set of filter coefficients of the chroma interpolation filter is determined based on a set of parameters of the DCT-IF with the cosine window. By way of example, the set of filter coefficients of the chroma interpolation filter is determined using equations as below: Dₖ=2/Size·cos (π·k·(2·l−2·Center+Size)/2·size). Wₖ=cos(π·k·(2·α−2·Center+Size)/2·Size), W₀=1/2, 1≤k≤Size−1, Filterₗ (α)=cos(π·l−β/N)·Σₖ₌₀^{Size-1}Wₖ(α)·Dₗₖ, p_{α}=Σ_{l=M}_{ₘᵢₙ}^{M}ₘₐₓFilterₗ(α)·pᵢ, Size=(Mₘᵢₙ+Mₘₐₓ−1), Center=Mₘᵢₙ+Mₘₐₓ/2 In this case, {pₗ} represents a set of sample values at integer position l used to interpolation p_{α} at fractional position α, Filterₗ (α) represents the set of filter coefficients, Mₘᵢₙ and Mₘₐₓ represents a range of neighboring integer-position samples involved in an interpolation process, Size represents the number of reference samples used in the chroma interpolation filter, and N represents a smoothing window size.

In some embodiments, the chroma interpolation filter is determined using DCT-IF with frequency domain smoothing. For example, a set of filter coefficients of the chroma interpolation filter is determined based on a set of parameters of the DCT-IF with the frequency domain smoothing. By way of example, the set of filter coefficients of the chroma interpolation filter is determined using equations as below: Dₖ=2/Size·cos(π·k·(2·l−2·Center+Size)/2·Size), Wₖ=cos(π·k·(2·α−2·Center+Size)/2·Size), W₀=1/2; 1≤k≤Size−1, \tilde{W}ₖ (α)=Wₖ (α)/1+σ·k², σ≥0. Filterₗ (α)=Σₖ₌₀^{Size-1}\tilde{W}ₖ(α)·Dₗₖ, p_{α}=Σ_{l=M}_{ₘᵢₙ}^{M}^{ₘₐₓ}Filterₗ (α)·pₗ, Size=(Mₘᵢₙ+Mₘₐₓ−1), and Center=Mₘᵢₙ+Mₘₐₓ/2. In this case, {pₗ} represents set of sample values at integer position l used to interpolation pα at fractional position α, Filterₗ (α) represents the set of filter coefficients, Mₘᵢₙ and Mₘₐₓ represents a range of neighboring integer-position samples involved in an interpolation process, Size represents the number of reference samples used in the chroma interpolation filter, N is represents a smoothing window size, and σ represents a smoothing parameter.

In some embodiments, usage of the chroma interpolation filter may be dependent on temporal layers. For example, the chroma interpolation filter is used for a layer with a temporal identity that is not greater than a predetermined value. In some embodiments, the predetermined value is 4.

In some embodiments, if the chroma interpolation filter comprises a first number of taps and another chroma interpolation filter comprises a second number of taps, the chroma interpolation filter is used for a first temporal layer and the other chroma interpolation filter is used for a second temporal layer. In some other embodiments, if the chroma interpolation filter comprises a filter tap and another chroma interpolation filter comprises a second filter tap, the chroma interpolation filter is used for a first temporal layer and the other chroma interpolation filter is used for a second temporal layer.

In some embodiments, usage of the chroma interpolation filter is dependent on coding information. For example the coding information comprises more quantization parameter (QP) values.

In some embodiments, if the chroma interpolation filter comprises a first number of taps and another chroma interpolation filter comprises a second number of taps, first chroma interpolation filter is used for a first QP value and the other chroma interpolation filter is used for a second QP value. In some other embodiments, if the chroma interpolation filter comprises a filter tap and another chroma interpolation filter comprises a second filter tap, the chroma interpolation filter is used for a first QP value and the other chroma interpolation filter is used for a second QP value.

In some embodiments, the coding information comprises a width and a height of at least one of: a current block, a current tile, or a current picture. In some embodiments, if the chroma interpolation filter comprises a first number of taps and another chroma interpolation filter comprises a second number of taps, the chroma interpolation filter is used for one of: a first width, a first height, a first max (W,H), or a first min (W,H), and the other chroma interpolation filter is used for one of: a second width, a second height, a second max (W,H), or a second min (W,H), and wherein W represents the width and H represents the height. In some other embodiments, if the chroma interpolation filter comprises a first filter tap and another chroma interpolation filter comprises a second filter tap, the chroma interpolation filter is used for one of: a first width, a first height, a first max (W,H), or a first min (W,H), and the other chroma interpolation filter is used for one of: a second width, a second height, a second max (W,H), or a second min (W,H), and wherein W represents the width and H represents the height.

In some embodiments, the coding information comprises a precision of motion vector (MV) or motion vector difference (MVD). In some embodiments, if the chroma interpolation filter comprises a first number of taps and another chroma interpolation filter comprises a second number of taps, the chroma interpolation filter is used for a first MV or MVD and the other chroma interpolation filter is used for a second MV or MVD. In some other embodiments, if the chroma interpolation filter comprises a first filter tap and another chroma interpolation filter comprises a second filter tap, the chroma interpolation filter is used for a first precision of MV or MVD and the other chroma interpolation filter is used for a second precision of MV or MVD.

In some embodiments, the coding information comprises a coding mode. In some embodiments, if the chroma interpolation filter comprises a first number of taps and another chroma interpolation filter comprises a second number of taps, the chroma interpolation filter is used for a first intra-prediction mode and the other chroma interpolation filter is used for a second intra-prediction mode. In some other embodiments, if the chroma interpolation filter comprises a first filter tap and another chroma interpolation filter comprises a second filter tap, the chroma interpolation filter is used for a first intra-prediction mode and the other chroma interpolation filter is used for a second intra-prediction mode.

In some embodiments, if the chroma interpolation filter comprises a first number of taps and another chroma interpolation filter comprises a second number of taps, the chroma interpolation filter is used for a first inter prediction mode and the other chroma interpolation filter is used for a second inter prediction mode. In some other embodiments, if the chroma interpolation filter comprises a first filter tap and another chroma interpolation filter comprises a second filter tap, the chroma interpolation filter is used for a first inter prediction mode and the other chroma interpolation filter is used for a second inter prediction mode.

In some embodiments, if the chroma interpolation filter comprises a first number of taps and another chroma interpolation filter comprises a second number of taps, the chroma interpolation filter is used for a first inter prediction direction and the other chroma interpolation filter is used for a second inter prediction direction. In some other embodiments, if the chroma interpolation filter comprises a first filter tap and another chroma interpolation filter comprises a second filter tap, the chroma interpolation filter is used for a first inter prediction direction and the other chroma interpolation filter is used for a second inter prediction direction.

In some embodiments, if the chroma interpolation filter comprises a first number of taps and another chroma interpolation filter comprises a second number of taps, whether to apply the chroma interpolation filter or the other chroma interpolation filter is based on a resolution of reference picture. In some other embodiments, if the chroma interpolation filter comprises a first filter tap and another chroma interpolation filter comprises a second filter tap, whether to apply the chroma interpolation filter or the other chroma interpolation filter is based on a resolution of reference picture.

In some embodiments, usage of the chroma interpolation filter is dependent on a color component or color format. For example, if the chroma interpolation filter comprises a first number of taps and another chroma interpolation filter comprises a second number of taps, the chroma interpolation filter is used for a first color component or a first color format and the other chroma interpolation filter is used for a second color component or a second color format. In some embodiments, if the chroma interpolation filter comprises a first filter tap and another chroma interpolation filter comprises a second filter tap, the chroma interpolation filter is used for a first color component or a first color format and the other chroma interpolation filter is used for a second color component or a second color format.

In some embodiments, a result of the chroma interpolation filter is clipped. In some other embodiments, usage of the chroma interpolation filter is indicated from an encoder to a decoder. In some embodiments, at least one index or flag indicating the chroma interpolation filter to be used is indicated from the encoder to the decoder. In some embodiments, the at least one index or flag indicates whether the chroma interpolation filter is used. In some embodiments, at least one chroma interpolation filter coefficient is derived based on information indicated from the encoder to the decoder. In some embodiments, the usage is indicated in one of the followings: a sequence level, a picture level, a slice level, or a block level. In some embodiments, the usage is indicated in one of the followings: a picture header, a sequence parameter set (SPS), a picture parameter set (PPS), an adaptation parameter sets (APS), a slice header, a coding tree unit (CTU), a coding unit (CU) or a prediction unit (PU).

According to further embodiments of the present disclosure, a non-transitory computer-readable recording medium is provided. The non-transitory computer-readable recording medium stores a bitstream of a video which is generated by a method performed by an apparatus for video processing. The method comprises: determining a chroma interpolation filter for a video unit of the video using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; and generating the bitstream based on the chroma prediction block.

According to still further embodiments of the present disclosure, a method for storing bitstream of a video is provided. The method comprises: determining a chroma interpolation filter for a video unit of the video using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; generating the bitstream based on the chroma prediction block; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, a chroma interpolation filter for the video unit using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; and performing the conversion based on the chroma prediction block.

Clause 2. The method of clause 1, wherein the chroma interpolation filter is a long tap chroma interpolation filter.

Clause 3. The method of clause 1, wherein the predetermined number is 4.

Clause 4. The method of clause 1, wherein the chroma interpolation filter is determined using DCT-IF with cosine window.

Clause 5. The method of clause 4, wherein a set of filter coefficients of the chroma interpolation filter is determined based on a set of parameters of the DCT-IF with the cosine window.

Clause 6. The method of clause 5, wherein a set of filter coefficients of the chroma interpolation filter is determined using equations as below: Dₖ=2/Size·cos(π·k·(2·l−2·Center+Size)/2·Size), Wₖ=cos(π·k·(2·α−2·Center+Size)/2·Size), W₀=1/2, 1≤k≤Size−1, Filterₗ(α)=cos(π·l−β/N)·Σₖ₌₀^{Size-1}Wₖ(α)·Dₗₖ, p_{α}=Σ_{l=M}_{ₘᵢₙ}^{M}^{ₘₐₓ}Filterₗ(α)·pₗ, Size=(Mₘᵢₙ+Mₘₐₓ−1), Center=Mₘᵢₙ+Mₘₐₓ/2, and wherein {pₗ} represents a set of sample values at integer position l used to interpolation p_{α} at fractional position α, Filterₗ (α) represents the set of filter coefficients, Mₘᵢₙ and Mₘₐₓ represents a range of neighboring integer-position samples involved in an interpolation process, Size represents the number of reference samples used in the chroma interpolation filter, and N represents a smoothing window size.

Clause 7. The method of clause 1, wherein the chroma interpolation filter is determined using DCT-IF with frequency domain smoothing.

Clause 8. The method of clause 7, wherein a set of filter coefficients of the chroma interpolation filter is determined based on a set of parameters of the DCT-IF with the frequency domain smoothing.

Clause 9. The method of clause 8, wherein a set of filter coefficients of the chroma interpolation filter is determined using equations as below: Dₖ=2/Size·cos(π·k·(2·l−2·Center+Size)/2·Size), Wₖ=cos(π·k·(2·α−2·Center+Size)/2·Size), W₀=1/2; 1≤k≤Size−1, \tilde{W}ₖ (α)=wₖ(α)/1+σ·k², σ≥0, Filterₗ (α)=Σₖ₌₀^{Size-1}\tilde{W}ₖ(α)·Dₗₖ, p_{α}=Σ_{l=M}_{ₘᵢₙ}^{M}^{ₘₐₓ}Filterₗ (α)·pₗ, Size=(Mₘᵢₙ+Mₘₐₓ−1), Center Mₘᵢₙ+Mₘₐₓ/2 and wherein {pₗ} represents set of sample values at integer position l used to interpolation p_{α} at fractional position α, Filterₗ (α) represents the set of filter coefficients, Mₘᵢₙ and Mₘₐₓ represents a range of neighboring integer-position samples involved in an interpolation process, Size represents the number of reference samples used in the chroma interpolation filter, N is represents a smoothing window size, and σ represents a smoothing parameter.

Clause 10. The method of clause 1, wherein usage of the chroma interpolation filter is dependent on temporal layers.

Clause 11. The method of clause 10, wherein the chroma interpolation filter is used for a layer with a temporal identity that is not greater than a predetermined value.

Clause 12. The method of clause 11, wherein the predetermined value is 4.

Clause 13. The method of clause 10, wherein if the chroma interpolation filter comprises a first number of taps and another chroma interpolation filter comprises a second number of taps, the chroma interpolation filter is used for a first temporal layer and the other chroma interpolation filter is used for a second temporal layer.

Clause 14. The method of clause 10, wherein if the chroma interpolation filter comprises a filter tap and another chroma interpolation filter comprises a second filter tap, the chroma interpolation filter is used for a first temporal layer and the other chroma interpolation filter is used for a second temporal layer.

Clause 15. The method of clause 1, wherein usage of the chroma interpolation filter is dependent on coding information.

Clause 16. The method of clause 15, wherein the coding information comprises more quantization parameter (QP) values.

Clause 17. The method of clause 16, wherein if the chroma interpolation filter comprises a first number of taps and another chroma interpolation filter comprises a second number of taps, first chroma interpolation filter is used for a first QP value and the other chroma interpolation filter is used for a second QP value.

Clause 18. The method of clause 16, wherein if the chroma interpolation filter comprises a filter tap and another chroma interpolation filter comprises a second filter tap, the chroma interpolation filter is used for a first QP value and the other chroma interpolation filter is used for a second QP value.

Clause 19. The method of clause 15, wherein the coding information comprises a width and a height of at least one of: a current block, a current tile, or a current picture.

Clause 20. The method of clause 19, wherein if the chroma interpolation filter comprises a first number of taps and another chroma interpolation filter comprises a second number of taps, the chroma interpolation filter is used for one of: a first width, a first height, a first max (W,H), or a first min (W,H), and the other chroma interpolation filter is used for one of: a second width, a second height, a second max (W,H), or a second min (W,H), and wherein W represents the width and H represents the height.

Clause 21. The method of clause 19, wherein if the chroma interpolation filter comprises a first filter tap and another chroma interpolation filter comprises a second filter tap, the chroma interpolation filter is used for one of: a first width, a first height, a first max (W,H), or a first min (W,H), and the other chroma interpolation filter is used for one of: a second width, a second height, a second max (W,H), or a second min (W,H), and wherein W represents the width and H represents the height.

Clause 22. The method of clause 15, wherein the coding information comprises a precision of motion vector (MV) or motion vector difference (MVD).

Clause 23. The method of clause 22, wherein if the chroma interpolation filter comprises a first number of taps and another chroma interpolation filter comprises a second number of taps, the chroma interpolation filter is used for a first MV or MVD and the other chroma interpolation filter is used for a second MV or MVD.

Clause 24. The method of clause 22, wherein if the chroma interpolation filter comprises a first filter tap and another chroma interpolation filter comprises a second filter tap, the chroma interpolation filter is used for a first precision of MV or MVD and the other chroma interpolation filter is used for a second precision of MV or MVD.

Clause 25. The method of clause 15, wherein the coding information comprises a coding mode.

Clause 26. The method of clause 25, wherein if the chroma interpolation filter comprises a first number of taps and another chroma interpolation filter comprises a second number of taps, the chroma interpolation filter is used for a first intra-prediction mode and the other chroma interpolation filter is used for a second intra-prediction mode.

Clause 27. The method of clause 25, wherein if the chroma interpolation filter comprises a first filter tap and another chroma interpolation filter comprises a second filter tap, the chroma interpolation filter is used for a first intra-prediction mode and the other chroma interpolation filter is used for a second intra-prediction mode.

Clause 28. The method of clause 25, wherein if the chroma interpolation filter comprises a first number of taps and another chroma interpolation filter comprises a second number of taps, the chroma interpolation filter is used for a first inter prediction mode and the other chroma interpolation filter is used for a second inter prediction mode.

Clause 29. The method of clause 25, wherein if the chroma interpolation filter comprises a first filter tap and another chroma interpolation filter comprises a second filter tap, the chroma interpolation filter is used for a first inter prediction mode and the other chroma interpolation filter is used for a second inter prediction mode.

Clause 30. The method of clause 25, wherein if the chroma interpolation filter comprises a first number of taps and another chroma interpolation filter comprises a second number of taps, the chroma interpolation filter is used for a first inter prediction direction and the other chroma interpolation filter is used for a second inter prediction direction.

Clause 31. The method of clause 25, wherein if the chroma interpolation filter comprises a first filter tap and another chroma interpolation filter comprises a second filter tap, the chroma interpolation filter is used for a first inter prediction direction and the other chroma interpolation filter is used for a second inter prediction direction.

Clause 32. The method of clause 25, wherein if the chroma interpolation filter comprises a first number of taps and another chroma interpolation filter comprises a second number of taps, whether to apply the chroma interpolation filter or the other chroma interpolation filter is based on a resolution of reference picture.

Clause 33. The method of clause 25, wherein if the chroma interpolation filter comprises a first filter tap and another chroma interpolation filter comprises a second filter tap, whether to apply the chroma interpolation filter or the other chroma interpolation filter is based on a resolution of reference picture.

Clause 34. The method of clause 1, wherein usage of the chroma interpolation filter is dependent on a color component or color format.

Clause 35. The method of clause 34, wherein if the chroma interpolation filter comprises a first number of taps and another chroma interpolation filter comprises a second number of taps, the chroma interpolation filter is used for a first color component or a first color format and the other chroma interpolation filter is used for a second color component or a second color format.

Clause 36. The method of clause 34, wherein if the chroma interpolation filter comprises a first filter tap and another chroma interpolation filter comprises a second filter tap, the chroma interpolation filter is used for a first color component or a first color format and the other chroma interpolation filter is used for a second color component or a second color format.

Clause 37. The method of clause 1, wherein a result of the chroma interpolation filter is clipped.

Clause 38. The method of clause 1, wherein usage of the chroma interpolation filter is indicated from an encoder to a decoder.

Clause 39. The method of clause 38, wherein at least one index or flag indicating the chroma interpolation filter to be used is indicated from the encoder to the decoder.

Clause 40. The method of clause 39, wherein the at least one index or flag indicates whether the chroma interpolation filter is used.

Clause 41. The method of clause 38, wherein at least one chroma interpolation filter coefficient is derived based on information indicated from the encoder to the decoder.

Clause 42. The method of clause 38, wherein the usage is indicated in one of the followings: a sequence level, a picture level, a slice level, or a block level.

Clause 43. The method of clause 38, wherein the usage is indicated in one of the followings: a picture header, a sequence parameter set (SPS), a picture parameter set (PPS), an adaptation parameter sets (APS), a slice header, a coding tree unit (CTU), a coding unit (CU) or a prediction unit (PU).

Clause 44. The method of any of clauses 1-43, wherein the conversion includes encoding the video unit into the bitstream.

Clause 45. The method of any of clauses 1-43, wherein the conversion includes decoding the video unit from the bitstream.

Clause 46. An apparatus for video processing comprising a processor and a non-transitory memory with instructions thereon, wherein the instructions upon execution by the processor, cause the processor to perform a method in accordance with any of clauses 1-45.

Clause 47. A non-transitory computer-readable storage medium storing instructions that cause a processor to perform a method in accordance with any of clauses 1-45.

Clause 48. A non-transitory computer-readable recording medium storing a bitstream of a video which is generated by a method performed by an apparatus for video processing, wherein the method comprises: determining a chroma interpolation filter for a video unit of the video using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; and generating the bitstream based on the chroma prediction block.

Clause 49. A method for storing a bitstream of a video, comprising: determining a chroma interpolation filter for a video unit of the video using a discrete cosine transform interpolation filter (DCT-IF), wherein the number of taps of the chroma interpolation filter is larger than a predetermined number; obtaining a chroma prediction block by applying the chroma interpolation filter to a chroma component of the video unit; generating the bitstream based on the chroma prediction block; and storing the bitstream in a non-transitory computer-readable recording medium.

### Example Device

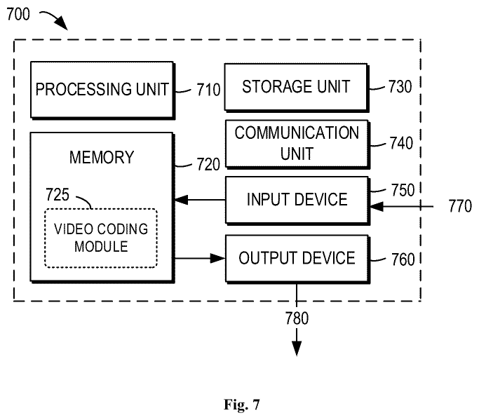

FIG. 7 illustrates a block diagram of a computing device 700 in which various embodiments of the present disclosure can be implemented. The computing device 700 may be implemented as or included in the source device 110 (or the video encoder 114 or 200) or the destination device 120 (or the video decoder 124 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement video encoding/decoding in embodiments of the present disclosure. The memory 720 may include one or more video coding modules 725 having one or more program instructions. These modules are accessible and executable by the processing unit 710 to perform the functionalities of the various embodiments described herein.

In the example embodiments of performing video encoding, the input device 750 may receive video data as an input 770 to be encoded. The video data may be processed, for example, by the video coding module 725, to generate an encoded bitstream. The encoded bitstream may be provided via the output device 760 as an output 780.

In the example embodiments of performing video decoding, the input device 750 may receive an encoded bitstream as the input 770. The encoded bitstream may be processed, for example, by the video coding module 725, to generate decoded video data. The decoded video data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, a chroma interpolation filter for the video unit using a discrete cosine transform interpolation filter (DCT-IF), wherein the number of taps of the chroma interpolation filter is larger than a predetermined number;
obtaining a chroma prediction block by applying the chroma interpolation filter to a chroma component of the video unit; and
performing the conversion based on the chroma prediction block.

2. The method of claim 1, wherein the chroma interpolation filter is a long tap chroma interpolation filter, or
wherein the predetermined number is 4, or
wherein the chroma interpolation filter is determined using DCT-IF with cosine window, or
wherein the chroma interpolation filter is determined using DCT-IF with frequency domain smoothing.

3. The method of claim 2, wherein a set of filter coefficients of the chroma interpolation filter is determined based on a set of parameters of the DCT-IF with the cosine window, and/or
wherein the set of filter coefficients of the chroma interpolation filter is determined using equations as below:
$${D}_{k} = \frac{2}{Size} \cdot cos ( \frac{π \cdot k \cdot ( 2 \cdot l - 2 \cdot Center + Size )}{2 \cdot Size} ) ,$$
$${W}_{k} = cos ( \frac{π \cdot k \cdot ( 2 \cdot α - 2 \cdot Center + Size )}{2 \cdot Size} ) ,$$
$${W}_{0} = \frac{1}{2} ,$$
$$1 \leq k \leq Size - 1 ,$$
$${Filter}_{l} ( α ) = cos ( π \cdot \frac{l - β}{N} ) \cdot {\sum }_{k = 0}^{Size - 1} {W}_{k} ( α ) \cdot {D}_{l k} ,$$
$${p}_{α} = {\sum }_{l = {M}_{min}}^{{M}_{max}} {Filter}_{l} ( α ) \cdot {p}_{l} ,$$
$$Size = ( {M}_{min} + {M}_{max} - 1 ) ,$$
$$Center = \frac{{M}_{min} + {M}_{max}}{2} , and$$
wherein {pₗ} represents a set of sample values at integer position l used to interpolation p_{α} at fractional position α, Filterₗ (α) represents the set of filter coefficients, Mₘᵢₙ and Mₘₐₓ represents a range of neighboring integer-position samples involved in an interpolation process, Size represents the number of reference samples used in the chroma interpolation filter, and N represents a smoothing window size.

4. The method of claim 2, wherein a set of filter coefficients of the chroma interpolation filter is determined based on a set of parameters of the DCT-IF with the frequency domain smoothing, and/or
wherein the set of filter coefficients of the chroma interpolation filter is determined using equations as below:
$${D}_{k} = \frac{2}{Size} \cdot cos ( \frac{π \cdot k \cdot ( 2 \cdot l - 2 \cdot Center + Size )}{2 \cdot Size} ) ,$$
$${W}_{k} = cos ( \frac{π \cdot k \cdot ( 2 \cdot α - 2 \cdot Center + Size )}{2 \cdot Size} ) ,$$
$${W}_{0} = \frac{1}{2} ,$$
$$1 \leq k \leq Size - 1 ,$$
$${Filter}_{l} ( α ) = cos ( π \cdot \frac{l - β}{N} ) \cdot {\sum }_{k = 0}^{Size - 1} {W}_{k} ( α ) \cdot {D}_{l k} ,$$
$${p}_{α} = {\sum }_{l = {M}_{min}}^{{M}_{max}} {Filter}_{l} ( α ) \cdot {p}_{l} ,$$
$$Size = ( {M}_{min} + {M}_{max} - 1 ) ,$$
$$Center = \frac{{M}_{min} + {M}_{max}}{2} , and$$
wherein {pₗ} represents set of sample values at integer position l used to interpolation p_{α} at fractional position α, Filterₗ (α) represents the set of filter coefficients, Mₘᵢₙ and Mₘₐₓ represents a range of neighboring integer-position samples involved in an interpolation process, Size represents the number of reference samples used in the chroma interpolation filter, N is represents a smoothing window size, and σ represents a smoothing parameter.

5. The method of claim 1, wherein usage of the chroma interpolation filter is dependent on temporal layers, or
wherein usage of the chroma interpolation filter is dependent on coding information, or
wherein usage of the chroma interpolation filter is dependent on a color component or color format, or
wherein a result of the chroma interpolation filter is clipped, or
wherein usage of the chroma interpolation filter is indicated from an encoder to a decoder.

6. The method of claim 5, wherein the chroma interpolation filter is used for a layer with a temporal identity that is not greater than a predetermined value, or
wherein if the chroma interpolation filter comprises a first number of taps and another chroma interpolation filter comprises a second number of taps, the chroma interpolation filter is used for a first temporal layer and the other chroma interpolation filter is used for a second temporal layer, or
wherein if the chroma interpolation filter comprises a filter tap and another chroma interpolation filter comprises a second filter tap, the chroma interpolation filter is used for a first temporal layer and the other chroma interpolation filter is used for a second temporal layer.

7. The method of claim 5, wherein the coding information comprises more quantization parameter (QP) values, or
wherein the coding information comprises a width and a height of at least one of: a current block, a current tile, or a current picture, or
wherein the coding information comprises a precision of motion vector (MV) or motion vector difference (MVD), or
wherein the coding information comprises a coding mode.

8. The method of claim 7, wherein if the chroma interpolation filter comprises a first number of taps and another chroma interpolation filter comprises a second number of taps, first chroma interpolation filter is used for a first QP value and the other chroma interpolation filter is used for a second QP value, or
wherein if the chroma interpolation filter comprises a filter tap and another chroma interpolation filter comprises a second filter tap, the chroma interpolation filter is used for a first QP value and the other chroma interpolation filter is used for a second QP value.

9. The method of claim 7, wherein if the chroma interpolation filter comprises a first number of taps and another chroma interpolation filter comprises a second number of taps, the chroma interpolation filter is used for one of: a first width, a first height, a first max (W,H), or a first min (W,H), and
the other chroma interpolation filter is used for one of: a second width, a second height, a second max (W,H), or a second min (W,H), and
wherein W represents the width and H represents the height, or
wherein if the chroma interpolation filter comprises a first filter tap and another chroma interpolation filter comprises a second filter tap, the chroma interpolation filter is used for one of: a first width, a first height, a first max (W,H), or a first min (W,H), and
the other chroma interpolation filter is used for one of: a second width, a second height, a second max (W,H), or a second min (W,H), and
wherein W represents the width and H represents the height.

10. The method of claim 7, wherein if the chroma interpolation filter comprises a first number of taps and another chroma interpolation filter comprises a second number of taps, the chroma interpolation filter is used for a first MV or MVD and the other chroma interpolation filter is used for a second MV or MVD, or
wherein if the chroma interpolation filter comprises a first filter tap and another chroma interpolation filter comprises a second filter tap, the chroma interpolation filter is used for a first precision of MV or MVD and the other chroma interpolation filter is used for a second precision of MV or MVD.

11. The method of claim 7, wherein if the chroma interpolation filter comprises a first number of taps and another chroma interpolation filter comprises a second number of taps, the chroma interpolation filter is used for a first intra-prediction mode and the other chroma interpolation filter is used for a second intra-prediction mode, or
wherein if the chroma interpolation filter comprises a first filter tap and another chroma interpolation filter comprises a second filter tap, the chroma interpolation filter is used for a first intra-prediction mode and the other chroma interpolation filter is used for a second intra-prediction mode, or
wherein if the chroma interpolation filter comprises a first number of taps and another chroma interpolation filter comprises a second number of taps, the chroma interpolation filter is used for a first inter prediction mode and the other chroma interpolation filter is used for a second inter prediction mode, or
wherein if the chroma interpolation filter comprises a first filter tap and another chroma interpolation filter comprises a second filter tap, the chroma interpolation filter is used for a first inter prediction mode and the other chroma interpolation filter is used for a second inter prediction mode, or
wherein if the chroma interpolation filter comprises a first number of taps and another chroma interpolation filter comprises a second number of taps, the chroma interpolation filter is used for a first inter prediction direction and the other chroma interpolation filter is used for a second inter prediction direction, or
wherein if the chroma interpolation filter comprises a first filter tap and another chroma interpolation filter comprises a second filter tap, the chroma interpolation filter is used for a first inter prediction direction and the other chroma interpolation filter is used for a second inter prediction direction, or
wherein if the chroma interpolation filter comprises a first number of taps and another chroma interpolation filter comprises a second number of taps, whether to apply the chroma interpolation filter or the other chroma interpolation filter is based on a resolution of reference picture, or
wherein if the chroma interpolation filter comprises a first filter tap and another chroma interpolation filter comprises a second filter tap, whether to apply the chroma interpolation filter or the other chroma interpolation filter is based on a resolution of reference picture.

12. The method of claim 5, wherein if the chroma interpolation filter comprises a first number of taps and another chroma interpolation filter comprises a second number of taps, the chroma interpolation filter is used for a first color component or a first color format and the other chroma interpolation filter is used for a second color component or a second color format, or
wherein if the chroma interpolation filter comprises a first filter tap and another chroma interpolation filter comprises a second filter tap, the chroma interpolation filter is used for a first color component or a first color format and the other chroma interpolation filter is used for a second color component or a second color format.

13. The method of claim 5, wherein at least one index or flag indicating the chroma interpolation filter to be used is indicated from the encoder to the decoder.

14. The method of claim 13, wherein the at least one index or flag indicates whether the chroma interpolation filter is used.

15. The method of claim 5, wherein at least one chroma interpolation filter coefficient is derived based on information indicated from the encoder to the decoder.

16. The method of claim 5, wherein the usage is indicated in one of the followings:
a sequence level,
a picture level,
a slice level, or
a block level, or
wherein the usage is indicated in one of the followings:
a picture header,
a sequence parameter set (SPS),
a picture parameter set (PPS),
an adaptation parameter sets (APS),
a slice header,
a coding tree unit (CTU),
a coding unit (CU) or
a prediction unit (PU).

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to:
determine, for a conversion between a video unit of a video and a bitstream of the video, a chroma interpolation filter for the video unit using a discrete cosine transform interpolation filter (DCT-IF), wherein the number of taps of the chroma interpolation filter is larger than a predetermined number;
obtain a chroma prediction block by applying the chroma interpolation filter to a chroma component of the video unit; and
perform the conversion based on the chroma prediction block.

19. A non-transitory computer-readable storage medium storing instructions that cause a processor to:
determine, for a conversion between a video unit of a video and a bitstream of the video, a chroma interpolation filter for the video unit using a discrete cosine transform interpolation filter (DCT-IF), wherein the number of taps of the chroma interpolation filter is larger than a predetermined number;
obtain a chroma prediction block by applying the chroma interpolation filter to a chroma component of the video unit; and
perform the conversion based on the chroma prediction block.

20. A non-transitory computer-readable recording medium storing a bitstream of a video which is generated by a method performed by an apparatus for video processing, wherein the method comprises:
determining, for a conversion between a video unit of a video and a bitstream of the video, a chroma interpolation filter for the video unit using a discrete cosine transform interpolation filter (DCT-IF), wherein the number of taps of the chroma interpolation filter is larger than a predetermined number;
obtaining a chroma prediction block by applying the chroma interpolation filter to a chroma component of the video unit; and
generating the bitstream based on the chroma prediction block.
